(19) United States
(12) Patent Application Publication
(10) Pub. No.: US 2017/0278596 A1
(43) Pub. Date: Sep. 28, 2017

(54) METHOD FOR PRODUCING METAL NANOWIRES HAVING IMPROVED UNIFORMITY IN LENGTH DISTRIBUTION

(71) Applicant: DOWA ELECTRONICS MATERIALS CO., LTD., Tokyo (JP)

(72) Inventors: Kimitaka SATO, Tokyo (JP); Hirotoshi SAITO, Tokyo (JP); Daisuke KODAMA, Tokyo (JP)

(21) Appl. No.: 15/506,786

(22) PCT Filed: Sep. 3, 2015
(86) PCT No.: PCT/JP2015/075086

§ 371 Date: Feb. 27, 2017

(30) Foreign Application Priority Data
Sep. 5, 2014 (JP) 2014-181790

(51) Int. Cl. H01B 13/00; H01B 5/14; C09D 11/52; H01B 13/32

(52) U.S. Cl. CPC H01B 13/0026; H01B 13/322; H01B 5/14; C09D 11/52; B82Y 40/00

(57) ABSTRACT

A method for producing metal nanowires having improved uniformity in length distribution and having a small abundance ratio of short nanowire comprises making metal nanowires to flow accompanied by a flow of a liquid medium in a tubular flow path having, on a wall of the flow path, a porous ceramic filter having an average pore diameter by the mercury intrusion method of 1.0 mm or more. A part of the flowing metal nanowires is discharged to an outside of the tubular flow path through the porous ceramic filter along with a part of the liquid medium and the metal nanowires that flow in the flow path but are not discharged to the outside of the tubular flow path are recovered.

### TECHNICAL FIELD

The present invention relates to a method for producing metal nanowires, which are useful as a material for forming a transparent conductive film, having improved uniformity in length distribution.

### BACKGROUND ART

In the description herein, an aggregate of minute metal wires having a thickness of approximately 200 nm or less is referred to as “nanowires”. Likening to powder, individual wire correspond to “particle” constituting the powder, and nanowires correspond to “powder” as an aggregate of the particle. In the description herein, the individual wire corresponding to particle of powder may be referred to as linear particle.

Metal nanowires are regarded as promising as a conductive material for imparting conductivity to a transparent substrate. A liquid containing metal nanowires (i.e., a metal nanowires ink) is coated on a transparent substrate, such as glass, PET (polyethylene terephthalate) , and PC (polycarbonate) , followed by removing the liquid component therefrom through evaporation or the like, and thereby the metal nanowires form a conductive network through contact among them on the substrate, resulting in a transparent conductive film. As a transparent conductive material, a metal oxide film, represented by ITO, has been frequently used. However, a metal oxide film has such defects as the high film forming cost and the weakness against bending, which may be a factor preventing the final product from becoming flexible. A conductive film of a touch sensitive panel sensor, which is one of the major applications of the transparent conductive film, is demanded to have high transparency and high conductivity, and the demand of visibility is also being increased recently. For enhancing the conductivity of the ordinary ITO film, it is necessary to increase the thickness of the ITO layer, but the increase of the thickness causes deterioration of the transparency, the improve in visibility cannot be achieved.

Metal nanowires are regarded as promising for avoiding the defects that are peculiar to the metal oxide film represented by ITO. In particular, silver nanowires have been subjected to practical use as a material for a transparent conductive film due to the progress of the industrial synthesis technique thereof.

The metal nanowires are generally synthesized by a wet process. Examples of the known method include a method of dissolving a silver compound in a polyol solvent, such as ethylene glycol, and depositing metallic silver in a linear shape by utilizing the reduction power of the polyol as the solvent in the presence of a halogen compound and PVC (polyvinylpyrrolidone) as a protective agent (PTL 1), and a method of depositing, in a solution containing a halogen compound and an organic amine in an alcohol as a solvent, metallic silver in a linear shape by utilizing the reduction power of the alcohol as the solvent (PTL 2). In the wet synthesis process, the reaction liquid generally contains by-products as impurities to be removed, such as metal particles that have not grown to the wire shape. As a method for removing the impurities, cross-flow filtration using a polymer material, such as a hollow fiber membrane, as a filter is known (PTLs 3 and 4).

### CITATION LIST

### Patent Literatures

PTL 1: US 2005/0056118

PTL 2: JP-A-2013-234341

PTL 3: Japanese Patent No. 5,507,440

PTL 4: JP-A-2013-199690

### SUMMARY OF INVENTION

### Technical Problem

In the removal of the impurities, such as particles, by the known cross-flow filtration, the metal nanowires to be recovered can be separated and recovered without accumulating on the filter, and thereby advantages are obtained that the damage on the metal nanowires is reduced, and the filtration process can be performed continuously. However, the cross-flow filtration using a polymer filter, such as a hollow fiber filter, is considerably difficult to apply to the optimization of the length distribution of the metal nanowires, for example, metal nanowires that have a relatively short length present in the liquid are removed to increase the abundance ratio of the long wires (linear particles) . A filter having a large pore diameter exceeding 1 μm cannot be produced at low cost with a polymer material. Therefore, it is essentially impossible to apply the filter, for example, to the purification operation, in which wires having a length of approximately from 1 to 5 μm (linear particles) are discharge to the outside through the pores. Furthermore, even if a special polymer filter having a large pore diameter can be achieved, when the clogging gradually proceeds in use, it is difficult to regenerate the filter by removing the metal substance, with which the pores are clogged. Accordingly, the polymer filter is basically not suitable for the repeated reuse and is necessarily exchanged, i.e., a so-called disposable system.

In the case where metal nanowires are used in a transparent conductive film, the wire form thereof is desirably as long as possible. Short wires (linear particles) not only are deteriorated in function of achieving conductivity, but also become a factor deteriorating the optical characteristics, such as the light transmittance and the haze, when the amount thereof present is large. The invention describes a method of separating and removing short wires (linear particles) and granular foreign matters with a reusable filter, which is a method that is particularly useful for enhancing the abundance ratio of long wires (linear particles).

### Solution to Problem

For achieving the object, the invention provides a method for producing metal nanowires having improved uniformity in length distribution, containing: making metal nanowires to flow accompanied by a flow of a liquid medium in a tubular flow path having, on a wall of the flow path, a porous ceramic filter having an average pore diameter by the mercury intrusion method of 1.0 μm or more, and more preferably exceeding 2.0 μm or 5.0 μm; discharging a part of the flowing metal nanowires to an outside of the tubular flow path through the porous ceramic filter along with a part of the liquid medium; and recovering the metal nanowires that flow in the flow path but are not discharged to the outside of the tubular flow path.

In general, the liquid medium having the metal nanowires present therein contains granular foreign matters, such as nanoparticles, in addition to the metal nanowires. When the liquid medium is made to flow in the tube of the porous ceramic filter, the granular foreign matters are efficiently discharged to the outside of the tubular flow path along with the short wires (linear particles).

The operation of removing the short wires and the granular foreign matters as much as possible from the liquid medium having the metal nanowires present therein, so as to enhance the abundance ratio of the long wires is referred to as “purification” in the description herein. In particular, the purification using the porous ceramic filter is referred to as “cross-flow purification”.

By the purification method of metal nanowires according to the invention, metal nanowires that have improved uniformity in length distribution are obtained as compared to the metal nanowires before the purification. Specifically, assuming that the average length of the metal nanowires before the purification is L₀ (μm), such metal nanowires can be produced that the number ratio of wires that are longer than L₀ is increased as compared to before the purification. The average length herein is in accordance with the definition later.

The method for producing metal nanowires having improved uniformity in length distribution in more detail is a method for producing metal nanowires performing purification containing: making metal nanowires to flow accompanied by a flow of a liquid medium in a tubular flow path having, on a wall of the flow path, a porous ceramic filter having an average pore diameter by the mercury intrusion method of 1.0 μm or more, and more preferably exceeding 2.0 μm or 5.0 μm; discharging a part of the flowing metal nanowires to an outside of the tubular flow path through the porous ceramic filter along with a part of the liquid medium; and recovering the metal nanowires that flow in the flow path but are not discharged to the outside of the tubular flow path, so as to produce metal nanowires having a length distribution having the number ratio of wires that are longer than the average length of the metal nanowires before the purification is increased as compared to before the purification.

The porous ceramic filter applied may have a pore diameter that is changed in the thickness direction (i.e., that is not uniform). In this case, it suffices that the average pore diameter that is measured for a porous material specimen collected from any portion in the thickness direction is 1.0 μm or more, and preferably exceeding 2.0 μm or 5.0 μm. For example, for a filter obtained by sintering ceramic particles having two kinds of particle diameters applied in such a manner that the inner portion is “sparse”, whereas the outer portion is “dense”, it suffices that the average pore diameter is evaluated with the porous material specimen collected from the outer portion, which is “dense”. With a larger average pore diameter, the short wires can be removed more efficiently. However, when the average pore diameter is too large, there may be cases where the decrease of the yield after the cross-flow purification becomes a problem. While the cross-flow purification can be performed with an average pore diameter in a range of 200 μm or less by controlling the flow rate and the like, it generally suffices that the average pore diameter is in a range of 100 μm or less, and more practically 50 μm or less. When the average pore diameter of the ceramic filter is larger than the maximum length of the metal nanowires to be subjected to the cross-flow purification, the long wires to be recovered are liable to be excluded through the pores of the ceramic filter along with the filtrate. Accordingly, the average pore diameter of the ceramic filter is preferably set in a range of the maximum length of the metal nanowires to be subjected to the cross-flow purification or less.

Examples of the metal nanowires introduced to the tubular flow path having the porous ceramic filter on the wall of the flow path, i.e., the metal nanowires before the cross-flow purification, include metal nanowires having a length distribution having a mixture of wires (linear particles) having a length of 5.0 μm or less and wires (linear particles) having a length exceeding 5.0 μm. According to the investigations made by the inventors, wires having a length of 5.0 μm or less have less usefulness for constituting a transparent conductive film. Accordingly, these short wires become an object that is positively removed in the purification process along with the granular foreign matters. The cross-flow purification applied to the invention is also effective for removing the granular foreign matters. As the metal nanowires having improved uniformity in length distribution that are recovered by the cross-flow purification process (i.e., the purified metal nanowires), silver nanowires having an average length of 8 μm or more and a number ratio of wires having a length of 5 μm or less of 20% or less are useful, and silver nanowires having an average length of 10 μm or more and a number ratio of wires having a length of 5 μm or less of 15% or less are more effective. The average diameter of the purified metal nanowires is preferably 50 nm or less, and more preferably 40 nm or less. The wires tends to be bent or broken in the process until the final product when the wires are too thin, and thus it generally suffices that the average diameter is 10 nm or more.

Assuming that the ratio of the average length (nm) and the average diameter (nm) of the metal nanowires is referred to as an average aspect ratio, the wires having an average aspect ratio of 250 or more are particularly preferably obtained through the purification. The average diameter, the average length, and the average aspect ratio are in accordance with the following definitions.

### Average Diameter

In a projected image of one metal wire on a micrograph image (for example, an FE-SEM image), the diameter of the inscribed circle in contact with the contours on both sides in the thickness direction is measured over the entire length of the wire, and the average value of the diameter is designated as the diameter of the wire. The value obtained by averaging the diameters of the individual wires constituting the nanowires is designated as the average diameter of the nanowires. The total number of the wires to be measured for calculating the average diameter is 100 or more.

### Average Length

In a projected image of one metal wire on the similar micrograph image as above, the length of the line passing through the thickness center (i.e., the center of the inscribed circle) of the wire from one end to the other end of the wire is designated as the length of the wire. The value obtained by averaging the lengths of the individual wires constituting the nanowires is designated as the average length of the nanowires. The total number of the wires to be measured for calculating the average length is 100 or more.

The silver nanowires according to the invention are constituted by wires having an extremely thin shape. Accordingly, the silver nanowires thus recovered are often in a curved string shape rather than a linear rod shape. The inventors have developed a software for measuring efficiently the wire length of the curved wire on an image, and utilize for the data processing.

### Average Aspect Ratio

The average aspect ratio is calculated by substituting the average diameter and the average length into the following expression (1).

(average aspect ratio)−(average length (nm))/(average diameter (nm)) (1)

### Advantageous Effects of Invention

The invention provides the following advantages.

(1) From a metal nanowires dispersion liquid, not only the granular impurity substances (such as nanoparticles), but also wires having a short length can be removed to provide metal nanowires having a large abundance ratio of wires having a large length. The uniformization of the length distribution of metal nanowires could have been achieved to some extent by a purification operation including repeated aggregation and precipitation. However, the purification operation requires a prolonged period of time and is not suitable for industrial production. According to the invention, the purification process can be reasonably performed within a short period of time.

(2) In the invention, cross-flow filtration is performed by using a porous ceramic filter having a very large pore diameter. The ceramic filter can be subjected to acid cleaning, as different from polymer materials (such as a hollow fiber membrane) having been applied to cross-flow filtration. Accordingly, the metal components, with which the filter is clogged, can be removed by acid cleaning, and thereby the filter can be repeatedly regenerated and reused, but not the disposable system.

(3) The cross-flow filtration applied to the invention can also be utilized as a rinsing process for the metal nanowires, simultaneously with the purification thereof. The load of the complicated solid-liquid separation operation having been performed in the rinsing process in the related-art can be reduced.

(4) In the case where the cross-flow filtration is performed with the circulation pathway shown in FIG. 3 described below, a liquid medium that is of a different kind from the solvent (dispersion medium) of the metal nanowires dispersion liquid before the cross-flow purification may be additionally added, and thereby the solvent (dispersion medium) of the metal nanowires dispersion liquid can be replaced therewith. According to the procedure, the operation for producing a metal nanowires ink having desired characteristics can be more efficiently performed.

(5) In the case where the cross-flow filtration is performed with the circulation pathway shown in FIG. 3 described below, a polymer, a dispersant, or a surfactant may be added to the circulation pathway, and thereby the substance covering the surface of the metal nanowires can be replaced therewith.

Accordingly, the invention is significantly useful in the industrial production of metal nanowires.

### BRIEF DESCRIPTION OF DRAWINGS

FIG. 1 is a cross sectional view schematically showing an example of the cross sectional structure of the flow path portion using a porous ceramic filter.

FIG. 2 is an illustration schematically showing the concept of purification by the cross-flow filtration using the porous ceramic filter.

FIG. 3 is an illustration schematically showing an example of the flow path line structure for the purification of metal nanowires.

FIG. 4 is an SEM micrograph of the silver nanowires obtained in Comparative Example 1.

FIG. 5 is an SEM micrograph of the supernatant collected in Comparative Example 1.

FIG. 6 is a graph showing the length distribution of the silver nanowires obtained in Comparative Example 1.

FIG. 7 is drawing substitute photographs showing the appearance of the porous ceramic tube used in Example 1.

FIG. 8 is SEM micrographs of the porous ceramic filter used in Example 1.

FIG. 9 is an SEM micrograph of the silver nanowires obtained in Example 1.

FIG. 10 is a graph showing the length distribution of the silver nanowires obtained in Example 1.

FIG. 11 is an SEM micrograph of the silver nanowires recovered as a filtrate in Example 1.

FIG. 12 is a graph showing the length distribution of the silver nanowires recovered as a filtrate in Example 1.

FIG. 13 is a graph showing the relationship between the sheet resistance and the transmittance.

FIG. 14 is a graph showing the relationship between the sheet resistance and the haze.

FIG. 15 is an SEM micrograph of the silver nanowires obtained in Comparative Example 2.

FIG. 16 is a graph showing the length distribution of the silver nanowires obtained in Comparative Example 2.

FIG. 17 is an SEM micrograph of the silver nanowires obtained in Example 2.

FIG. 18 is a graph showing the length distribution of the silver nanowires obtained in Example 2.

FIG. 19 is an SEM micrograph of the silver nanowires recovered as a filtrate in Example 2.

FIG. 20 is a graph showing the length distribution of the silver nanowires recovered as a filtrate in Example 2.

FIG. 21 is a graph showing the length distribution of the silver nanowires after the rinsing process in Example 3.

FIG. 22 is a graph showing the length distribution of the silver nanowires after the cross-flow purification obtained in Example 3.

### DESCRIPTION OF EMBODIMENTS

FIG. 1 schematically illustrates the cross sectional structure of a flow path portion using a porous ceramic filter that is applicable to the invention. The example shown herein uses a porous ceramic tube. An upstream flow path tube 2 is connected to one end of the porous ceramic tube 1, and a downstream flow path tube 3 is connected to the other end thereof. Metal nanowires flowing along with a liquid medium in the direction shown by the arrow A in the upstream flow path tube 2 are introduced into the inside of the porous ceramic tube 1. The ceramics of the porous ceramic tube 1 have a porous structure having an average pore diameter of 1.0 μm or more, preferably exceeding 2.0 μm, and more preferably exceeding 5.0 μm, and a substance is movable through gaps connected in the thickness direction thereof. Thus, the tube wall of the porous ceramic tube 1 constitute a “porous ceramic filter” capable of transmitting a substance. In the length in the longitudinal direction of the porous ceramic tube 1, the portion of the “tubular flow path having the porous ceramic filter on the wall of the flow path” functioning as a filter is shown by the symbol 10 in the figure. In the portion of the tubular flow path 10, while the metal nanowires proceed in the direction of the arrows B along with the flow of the liquid medium, apart of the flowing metal nanowires are transmitted through the tube wall of the porous ceramic tube 1 along with a part of the liquid medium, and discharged to the outside of the tubular flow path 10 as shown by the arrows C, thereby achieving cross-flow filtration. In the cross-flow filtration, the wires having a short length in the metal nanowires flowing in the tubular flow path 10 are preferentially discharged to the outside, and therefore the metal nanowires that proceed in the direction of the arrow D without discharging to the outside in the portion of the tubular flow path 10 have an increased abundance ratio of the wires having a large length. By recovering those metal nanowires, the metal nanowires having improved uniformity in length distribution (i.e., having a larger average length than the metal nanowires before reaching the tubular flow path having the ceramic filter) are produced.

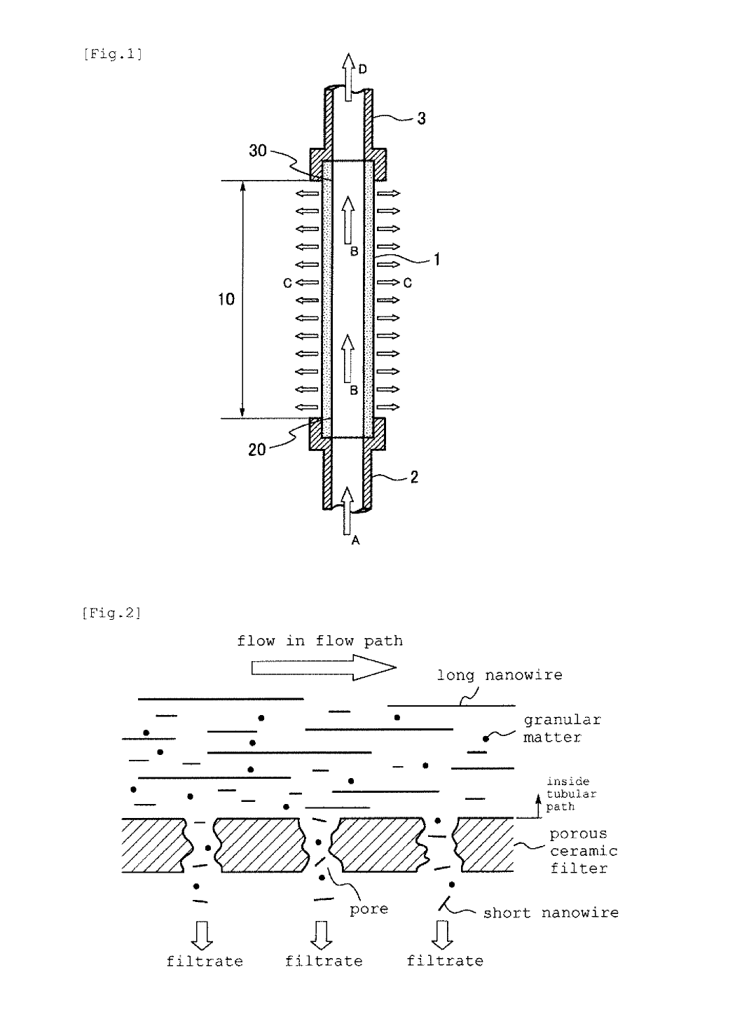

FIG. 2 schematically shows the concept of purification by the cross-flow filtration using the porous ceramic filter. Through the pores of the porous ceramic filter (which are actually continuous gaps) , not only granular impurities, but also the relatively short nanowires are discharged to the outside along with the liquid medium. The probability of discharging the wires that have a fairly larger length than the pore diameter to the outside through the pores is extremely small. The liquid thus discharged to the outside is referred to as a “filtrate”.

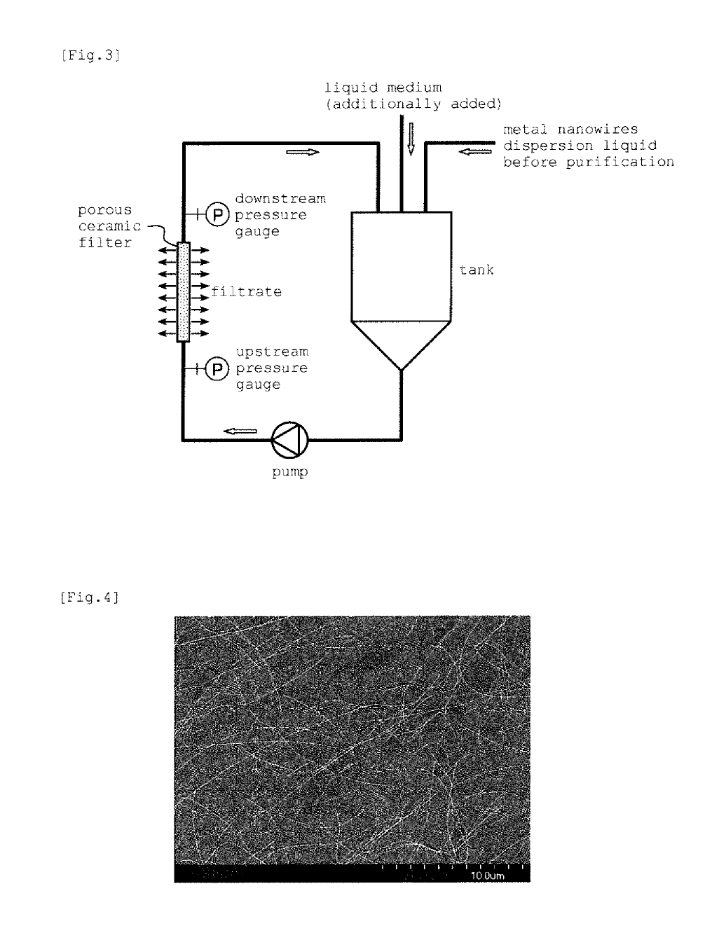

FIG. 3 schematically shows an example of the tubular path structure for the purification of metal nanowires. The metal nanowires dispersion liquid before purification is prepared in the tank, and is made to flow in the tubular flow path having the porous ceramic filter on the wall of the flow path with the power of the pump, and the cross-flow filtration is performed herein. The short wires are discharged as a filtrate to the outside of the tubular path, and the metal nanowires that proceed in the flow path without discharging to the outside of the tubular flow path are recovered. While FIG. 3 illustrates the “circulation system”, in which the recovered metal nanowires are returned to the former tank, a batch process may also be used, in which the recovered metal nanowires are recovered into another tank. In the case where the purification is performed continuously by the circulation system, the liquid medium is appropriately added in an amount corresponding to the discharged amount of the filtrate. With a longer circulation time, or a larger number of repetition of the batch process, the uniformity in length distribution of the metal nanowires is increased. According to the investigation by the inventors, for the purpose applied to a transparent conductive film, it is effective to perform the purification until the silver nanowires having an average length of 8 μm or more and a number ratio of wires having a length of 5 μm or less of 20% or less are recovered, and it is more effective to perform the purification until the silver nanowires having an average length of 10 μm or more and a number ratio of wires having a length of 5 μm or less of 15% or less are recovered. However, excessive cross-flow filtration may be a factor causing damages of the long wires to be recovered, and attention is necessary focused thereon.

The liquid feed pump used is not particularly limited as far as the pump can feed a liquid containing metal nanowires, and is preferably a pump that prevents breakage (such as rupture, fracture, and entanglement) of the wires as much as possible, and is capable of feeding the liquid at a relatively high pressure. Examples thereof include a hose pump, a tube pump, a rotary pump, a Moineau pump, a screw pump, a piston pump, a syringe pump, a plunger pump, and a heart pump.

The pressure of the liquid introduced into the tubular flow path containing the porous ceramic filter on the wall of the flow path may be controlled, for example, in a range of from 0.01 to 0.2 MPa. The flow rate of the liquid introduced into the tubular flow path the porous ceramic filter on the wall of the flow path containing may be controlled, for example, in a range of from 10 to 10,000 mm/sec, at the upstream end of the filter (i.e., the position corresponding to the numeral 20 in FIG. 1). The invention uses a ceramic filter having an extremely large pore diameter, and therefore clogging can be relieved when the purification is performed at a relatively large flow rate, thereby providing good results.

The liquid medium that is made to flow in the tubular flow path containing the porous ceramic filter on the wall of the flow path maybe various ones as far as the metal nanowires are not aggregated therein. The dispersion liquid of metal nanowires often contains a salt, a low molecular weight dispersant, a polymer dispersant, and the like through the synthesis process of the wires and the subsequent processes. A solvent capable of dissolving the substances that are desired to be removed among them is preferably selected as the liquid medium. In general, methyl alcohol, ethyl alcohol, 1-propanol, 2-propanol, 1-butanol, water, mixed solvents, and the like may be used.

In the case where the cross-flow filtration is performed continuously with the circulation pathway shown in FIG. 3, a liquid medium (solvent B) that is of a different kind from the liquid medium (solvent A) of the original metal nanowires dispersion liquid may be additionally added, and thereby the dispersion medium can be replaced from the solvent A to the solvent B. According to the procedure, the operation for producing a metal nanowires ink having desired characteristics corresponding to the purpose can be more efficiently performed.

In the cross-flow filtration, a part of the liquid medium is discharged as the filtrate, and therefore the amount of the liquid medium in the circulation pathway is gradually decreased by the cross-flow filtration performed in the pathway. Accordingly, in the continuous operation of the cross-flow filtration, a replenishment operation of the liquid medium into the circulation pathway is generally necessary. However, the concentration of the metal nanowires in the liquid can be increased by utilizing the decrease of the liquid medium. In other words, the process of the cross-flow filtration can be utilized as a condensing process of the metal nanowires dispersion liquid. In this case, it suffices that the replenishment amount of the liquid medium is controlled smaller than the amount that is discharged through the filtration. Such a procedure may also be employed that the replenishment of the liquid medium is terminated after performing the cross-flow filtration for a certain period of time.

In the process of the cross-flow filtration, a polymer or a dispersant that enhances the dispersibility may be added to the liquid medium, and thereby the dispersibility of the metal nanowires and the granular foreign matters (such as the nanoparticles) can be enhanced. According to the procedure, the removal of the short wires (linear particles) and the granular foreign matters with the ceramic filter can be performed more smoothly.

In general, the polymer used in the synthesis of the metal nanowires is adsorbed on the surface of the linear particle of the metal nanowires. In the case where the cross-flow filtration is continuously performed, an organic compound that is of a different kind from the polymer used in the synthesis may be added to the liquid medium, and a dispersant or a surfactant may be added thereto depending on necessity, thereby replacing the substance adsorbed on the surface of the wires by the organic compound.

The purification by using the cross-flow filtration can also be utilized as a rinsing process. The rinsing of metal nanowires is generally performed by subjecting the slurry after the synthesis to a solid-liquid separation procedure, such as centrifugal separation and decantation. Examples of the decantation method include a method of condensing for approximately from 2 to 3 weeks while standing still, and a method of condensing by increasing the sedimentation rate by adding one or more kinds of a solvent having small polarity, such as acetone, toluene, hexane, and kerosene, to the slurry. The decantation is performed preferably with a glass vessel coated with a fluorine resin. The fluorine resin coating has an effect of preventing the hydrophilic nanowires from being attached to the surface of the vessel, so as to enhance the yield. In the case of the centrifugal separation, the metal nanowires can be condensed by subjecting the slurry after reaction directly to a centrifugal separator. After condensing, the supernatant is removed, then a solvent having large polarity, such as water and an alcohol, is added to disperse the metal nanowires again, and the solid content is recovered by solid-liquid separation by using such procedure as centrifugal separation and decantation, thereby rinsing the metal nanowires carefully. The purification using the cross-flow filtration according to the invention also exhibits a rinsing effect, and thus the load of the aforementioned ordinary rinsing process can be reduced. In consideration of the purpose of a conductive film mounted in an electronic device, the rinsing is preferably performed to a conductivity of the metal nanowires dispersion liquid of 10 mS/m or less, more preferably 5 mS/m or less, and further preferably 1 mS/m or less, for preventing the capabilities of the electronic components from being deteriorated by the salts remaining in the dispersion liquid.

It is effective that the metal nanowires selected to be subjected to cross-flow filtration are ones having a broad length distribution containing short wires to be removed and long wires to be recovered as a mixture. According to the invention, the short wires are preferentially removed, and thereby the abundance ratio of the long wires to be recovered can be considerably enhanced. The synthesis method of the metal nanowires may not be particularly limited, and a synthesis method by a wet process has been currently known. In the case of silver nanowires, for example, the reductive deposition method shown in PTLs 1 and 2 has been known. In addition, as a method advantageous for synthesis of thin and long silver nanowires, the applicant discloses a method of adding a prescribed amount of an aluminum salt to an alcohol solvent in Patent Application No. 2014-045754. As a synthesis method of copper nanowires, a method is disclosed by a part of the inventors of the application and other inventors in Patent Application No. 2014-036073.

### EXAMPLE

### Comparative Example 1

Silver nanowires synthesized in a propylene glycol solvent according to the technique described in Patent Application No. 2014-045754 were prepared. Nanowires synthesized in a 1 L beaker were used herein. The reaction liquid (containing the silver nanowires) after the synthesis was subjected to the following rinsing process.

### Purification and Rinsing Process

To the reaction liquid cooled to room temperature, acetone was added in an amount of 10 times the reaction liquid, and after agitating for 10 minutes, the mixture was allowed to stand for 24 hours. After allowing to stand, a condensed matter and a supernatant were observed, and the supernatant was carefully removed with a pipette to provide the condensed matter. The resulting condensed matter was added to 500 g of pure water, which was agitated for 10 minutes to disperse the condensed matter, acetone was added thereto in an amount of 10 times, and after agitating, the mixture was allowed to stand for 24 hours. After allowing to stand, a condensed matter and a supernatant were newly observed, and the supernatant was carefully removed with a pipette. An excessive amount of an organic protective agent was unnecessary for providing good conductivity, and therefore the rinsing operation was repeated to rinse the solid matter sufficiently. In the purification and rinsing process, silver nanoparticles as a by-product and extremely short silver nanowires are removed to some extent as the supernatant since they are difficult to be precipitated. However, it is considerably difficult to remove nanowires having a length of approximately 1 μm or more by the method repeating aggregation and dispersion. Accordingly, nanowires of 5 μm or less, which exhibit less contribution to the conductivity of the transparent conductor and are liable to be a factor of haze thereof, substantially cannot be removed but remain.

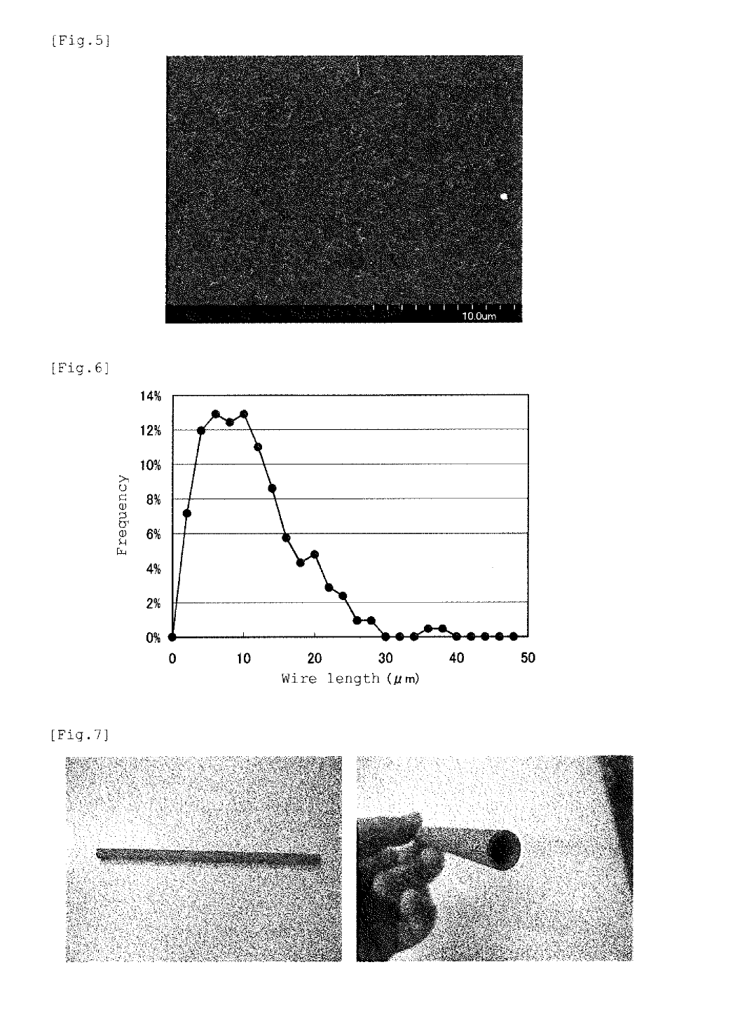

Pure water was added to the rinsed solid matter to provide a dispersion liquid. The dispersion liquid was sampled, and after evaporating pure water as the solvent on an observation pad, the observation with a high resolution FE-SEM (high resolution field emission scanning electron microscope) of the solid matter revealed that the solid matter was silver nanowires. FIG. 4 shows the SEM micrograph of the silver nanowires. In the SEM observation, the average diameter and the average length were obtained according to the aforementioned definitions for all the silver nanowires observed in a view field arbitrarily selected as the measurement object. The total number of the wires as the measurement object was 100 or more. The measurement of the diameter was performed at a magnification of 150,000 for the high resolution SEM, and the measurement of the length was performed at a magnification of 2,500 for the high resolution SEM. As a result, the average length of the silver nanowires was 9.9 μm, and the number ratio of 5.0 μm or less thereof was 24.4%. The average diameter thereof was 30.3 nm, and the average aspect ratio thereof was 9,900/30.3≈327. For reference, FIG. 5 shows the SEM micrograph of the supernatant collected after allowing to stand. It is understood therefrom that only granular matters and extremely short wires can be removed.

FIG. 6 shows the length distribution (number ratio) of the silver nanowires obtained in this example.

### Production of Transparent Conductive Film

A solvent having a mass ratio of pure water/isopropyl alcohol of 8/2 was added to the rinsed solid matter, to which 0.3% by mass of hydroxypropyl methyl cellulose as a thickener was added to make a viscosity at 50 rpm in a rotary viscometer (HAAKE RheoStress 600, produced by Thermo Scientific, measurement cone: Cone C60/1° Ti (D=60 mm) , plate: Meas. Plate cover MPC60) of from 25 to 35 mPas, thereby providing an ink. The silver nanowires content in the ink was controlled to 0.3% by mass. The silver nanowires ink was coated on a surface of a PET film (Lumirror 11048, produced by Toray Industries, Inc.) having a size of 10 cm×5 cm with bar coaters of Nos. 3 to 20, so as to form coated films having various thicknesses. A larger count of the bar coater provides a thicker coated film. The coated films were dried at 120° C. for 1 minute. The dried coated films were measured for sheet resistance with Loresta HP Model MCP-T410, produced by Mitsubishi Chemical Analytech Co., Ltd. The dried coated films were measured for total light transmittance with Haze Meter NDH 5000, produced by Nippon Denshoku Industries Co., Ltd. For removing the influence of the PET substrate from the values of the total light transmittance and the haze, the total light transmittance used was a value of (total light transmittance including substrate)+(100%−(transmittance of only substrate)), the haze used was a value of (haze including substrate)−(haze of only substrate).

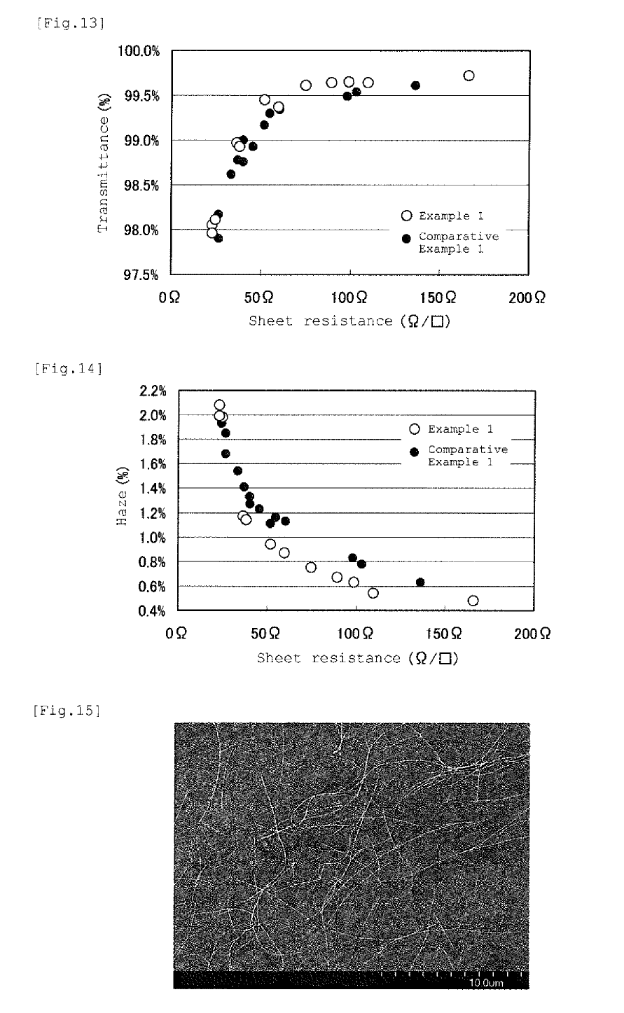

The results are shown by the solid circles in FIGS. 13 and 14 later.

The silver nanowires of this example were dissolved in 60% nitric acid under heating to provide a solution, which was measured for Al content by the ICP atomic emission spectroscopic analysis method (equipment: ICP atomic emission spectrometer 720-ES, produced by Agilent Technologies, Inc.) , and the Al content in the metal component was 430 ppm.

### Example 1

### Cross-flow Purification Process

The silver nanowires dispersion liquid obtained through the purification and rinsing process in Comparative Example 1 (corresponding to FIGS. 4 and 6) was diluted with pure water to make a silver nanowires concentration of 0.03% by mass, and purified by subjecting to cross-flow filtration using a porous ceramic filter. The silver nanowires were prepared in an amount that was necessary for providing a total amount of 5 L.

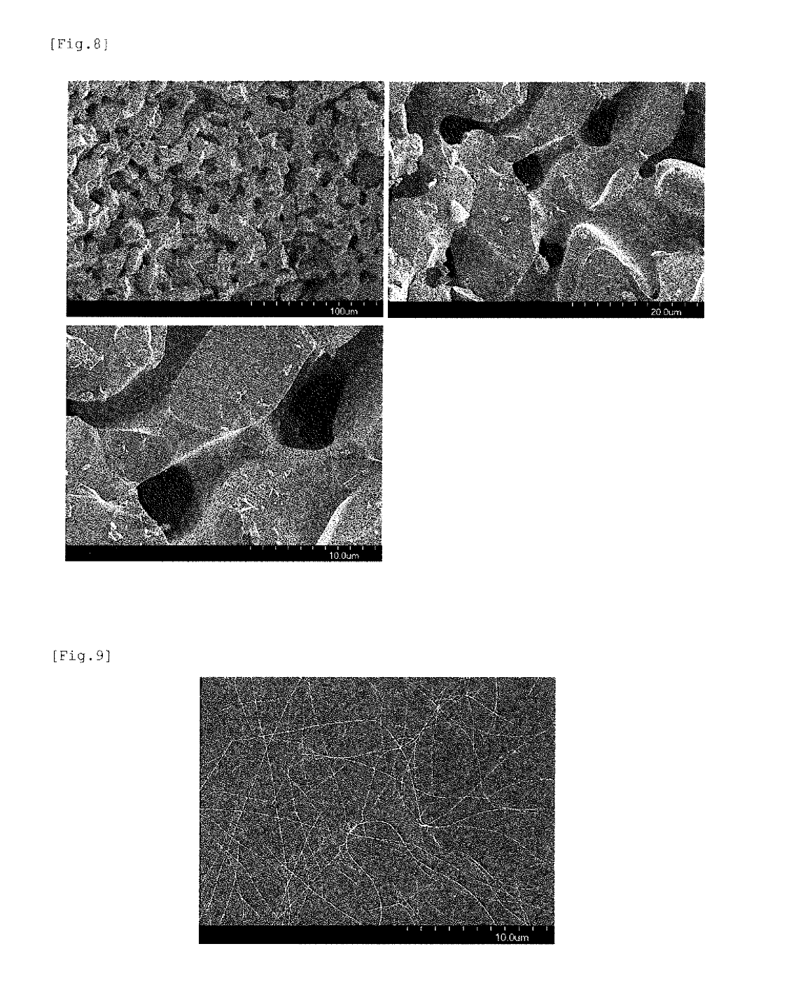

FIG. 7 shows the photographs showing the appearance of the porous ceramic tube used. FIG. 8 shows the SEM micrographs of the porous ceramic filter. The material for the ceramics was SiC (silicon carbide), and the dimension thereof was 12 mm for the outer diameter, 9 mm for the inner diameter, and 250 mm for the length. The porous ceramic filter had an average pore diameter of 8.25 μm measured by the mercury intrusion method with a mercury porosimeter, produced by Micrometrics, Inc. The porous ceramic filter had a pore volume of 0.192 cm³/g, a density of 1.82 g/cm³, a true density of 2.80 g/cm³, and a porosity of 35.0%.

The detailed conditions in the measurement of the pore distribution by the mercury intrusion method were as follows.

Measurement device: AutoPore Model IV 9510

Measurement range: 450 to 0.003 μm in diameter

Mercury contact angle: 130°

Mercury surface tension: 485 dynes/cm

Pretreatment: 300° C. for 1 hour (in the air)

Mass of measurement specimen: 1 g

For sufficiently ensuring the measurement accuracy, the measurement data for 80 points were collected in a measurement range of from 1 to 100 μm. The average pore diameter herein is a median diameter.

A flow path having the structure shown in FIG. 3 was formed, and cross-flow filtration was performed by the circulation system. The length of the “tubular flow path having a porous ceramic filter on the wall of the flow path” corresponding to the portion shown by the symbol 10 in FIG. 1 was 230 mm. The rinsed silver nanowires dispersion liquid obtained by the method in Comparative Example 1 was diluted with pure water to provide 5 L of a dispersion liquid having a silver nanowires content of 0.03% by mass. The dispersion liquid was placed in the tank shown in FIG. 3 and circulated at a flow rate of the liquid introduced to the filter of 20 L/min. The pressure at the upstream side of the filter was 0.03 MPa. The dispersion liquid was circulated for 70 hours while replenishing pure water in an amount corresponding to the amount of the liquid discharged as a filtrate. The filter was being clogged, and thus the discharged amount of the filtrate was gradually decreased, but not abruptly decreased. Herein, the ceramic filter was exchanged every 25 hours. The used filter was regenerated by rinsing with nitric acid, and then reused sequentially. After circulating for 70 hours, the circulation was continued for further 200 hours without the replenishment of the liquid, and thereby the dispersion liquid was condensed by utilizing the decrease of the liquid amount by discharging the filtrate. The silver nanowires dispersion liquid thus obtained through the purification had a silver nanowires concentration of 1.2% by mass.

FIG. 9 shows the SEM micrograph of the silver nanowires thus recovered after the purification. The average length of the silver nanowires was 13.9 μm, and the number ratio of 5.0 μm or less thereof was 10.0%. The average length of the silver nanowires before the purification was 9.9 μm, and the number ratio of 5 μm or less thereof was 24.4% (see Comparative Example 1), from which it was understood that the short nanowires were discharged and removed through the cross-flow filtration performed in this example of the invention, thereby increasing the average length consequently. The average diameter of the silver nanowires thus recovered was 30.3 nm, and the average aspect ratio thereof was 13,900/30.3≈459.

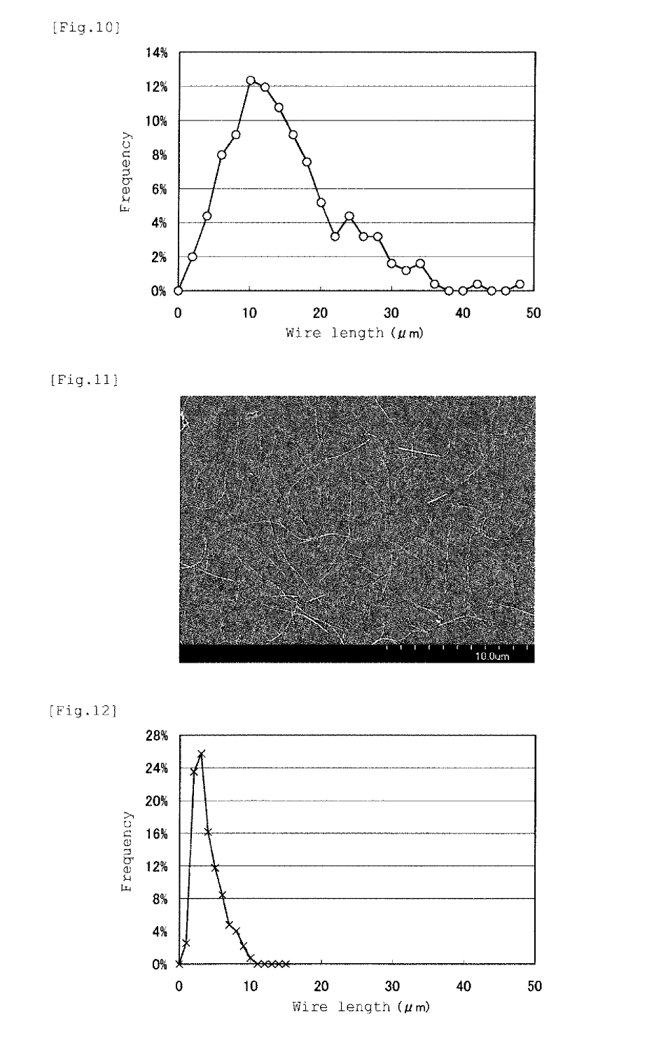

FIG. 10 shows the length distribution (number ratio) of the silver nanowires obtained in this example. The ratio of the short wires was considerably decreased as compared to those before the purification (FIG. 6).

For reference, FIG. 11 shows the SEM micrograph of the silver nanowires recovered as the filtrate of the cross-flow filtration. FIG. 12 shows the length distribution (number ratio) of the silver nanowires recovered from the filtrate. It was understood therefrom that not only the granular matters but also the metal nanowires having a relatively short length were able to be discharged to the side of the filtrate by the cross-flow filtration using the porous ceramic filter having an extremely large average pore diameter. The average length of the silver nanowires on the side of the filtrate was 3.4 μm, and the number ratio of 5.0 μm or less was 79.8%.

### Production of Transparent Conductive Film

An ink and a transparent conductive film were produced and evaluated under the same conditions as in Comparative Example 1.

FIG. 13 shows the relationship between the sheet resistance and the transmittance. FIG. 14 shows the relationship between the sheet resistance and the haze. In the figures, the results of Example 1 are shown by the open circles, and the results of Comparative Example 1 are shown by the solid circles. In Example 1 having a small abundance ratio of short wires, there was a tendency that the transmittance was increased with the same sheet resistance, and in the region providing a high transmittance (for example, a region having a sheet resistance of 50Ω per square or more providing a transmittance of 99% in the transparent sheet produced herein), the haze was remarkably decreased stably. Accordingly, it was understood that only the short metal nanowires were removed as much as possible, and thereby a transparent conductive film had a clear visibility with a high light transmittance and a low haze.

### Comparative Example 2

While the silver nanowires synthesized in a 1 L beaker were used in Comparative Example 1, silver nanowires synthesized in a 10 L beaker were used herein. A silver nanowires dispersion liquid was obtained in the same manner till the rinsing process as in Comparative Example 1 except that the amount of the substances was increased 16 times.

FIG. 15 shows the SEM micrograph of the resulting silver nanowires. The average length of the silver nanowires was 6.4 μm, and the number ratio of 5 μm or less thereof was 48.0%. The average diameter thereof was 30.1 nm, and the average aspect ratio thereof was 6,400/30.1≈213. FIG. 16 shows the length distribution (number ratio) of the silver nanowires obtained in this example.

Such a result was obtained that the amount of the nanowires of 5 μm or less was markedly larger, and the average length was shorter, than in Comparative Example 1.

### Example 2

The silver nanowires obtained in Comparative Example 2 were purified by cross-flow filtration in the same manner as in Example 1.

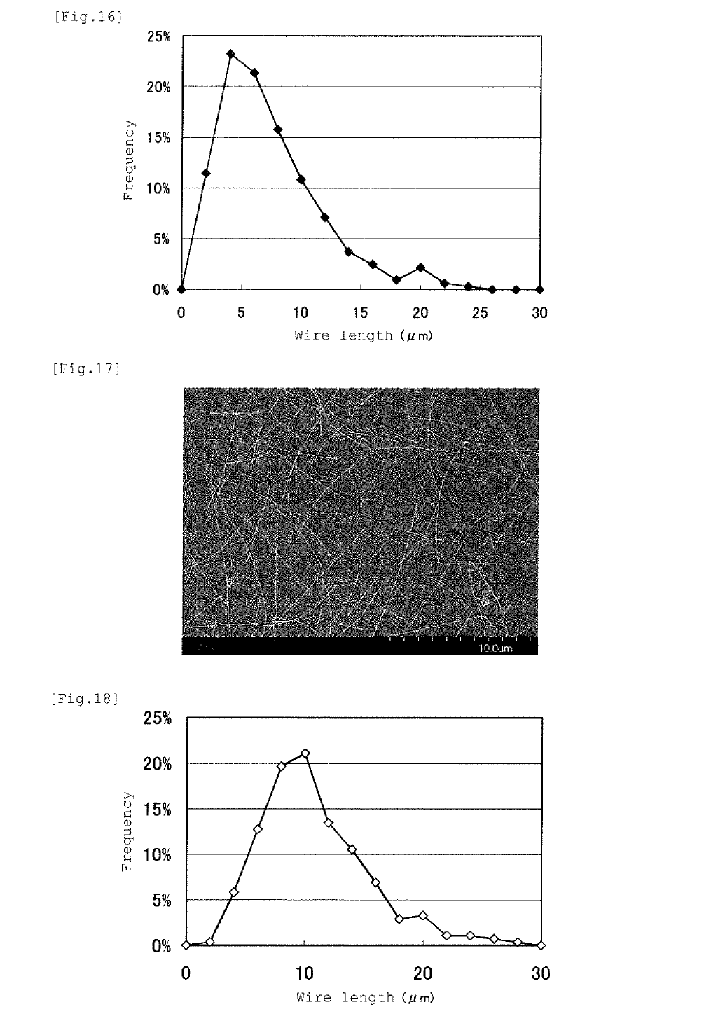

FIG. 17 shows the SEM micrograph of the silver nanowires thus recovered after the purification. The average length of the silver nanowires was 10.0 μm, and the number ratio of 5.0 μm or less thereof was 15.0%. The average diameter thereof was 30.1 nm, and the average aspect ratio thereof was 10,000/30.1≈333.

FIG. 18 shows the length distribution (number ratio) of the silver nanowires obtained in this example. The ratio of the short wires was considerably decreased as compared to those before the purification (FIG. 16).

For reference, FIG. 19 shows the SEM micrograph of the silver nanowires recovered as the filtrate of the cross-flow filtration. FIG. 20 shows the length distribution (number ratio) of the silver nanowires recovered from the filtrate.

### Example 3

### Synthesis Process of Nanowires

Silver nanowires were obtained in the following manner.

The following materials were prepared: propylene glycol (1,2-propanediol) as an alcohol solvent, silver nitrate as a silver compound, lithium chloride as a chloride, potassium bromide as a bromide, lithium hydroxide as an alkali metal hydroxide, aluminum nitrate nonahydrate as an aluminum salt, and a copolymer of vinylpyrrolidone and diallyldimethylammonium nitrate (the copolymer was formed with 99% by mass of vinylpyrrolidone and 1% by mass of diallyldimethylammonium nitrate, weight average molecular weight: 130,000) as an organic protective agent.

At room temperature, to 25.0 g of propylene glycol, 0.15 g of a propylene glycol solution containing 1% by mass of lithium chloride, 0.10 g of a propylene glycol solution containing 0.25% by mass of potassium bromide, 0.20 g of a propylene glycol solution containing 1% by mass of lithium hydroxide, 0.16 g of a propylene glycol solution containing 2% by mass of aluminum nitrate nonahydrate, and 0.26 g of the copolymer of vinylpyrrolidone and diallyldimethylammonium nitrate were added and dissolved by agitation to provide a solution A. In a separate vessel, 0.21 g of silver nitrate was added and dissolved in 1 g of propylene glycol to provide a solution B.

The entire amount of the solution A was heated from room temperature to 90° C. over an oil bath under agitation with an agitator coated with a fluorine resin at 300 rpm, and then the entire amount of the solution B was added to the solution A over 1 minute. After completing the addition of the solution B, the mixture was retained at 90° C. for 24 hours while retaining the agitation state. Thereafter, the reaction liquid was cooled to room temperature.

### Rinsing Process

To the reaction liquid cooled to room temperature, acetone was added in an amount of 20 times the reaction liquid, and after agitating for 10 minutes, the mixture was allowed to stand for 24 hours. After allowing to stand, a condensed matter and a supernatant were observed, and the supernatant was carefully removed with a pipette to provide the condensed matter. The resulting condensed matter was diluted with pure water containing 1% of PVP (polyvinylpyrrolidone) having a molecular weight of 55,000 to make the silver nanowires concentration to 0.01% by mass. The silver nanowires were prepared in an amount that was necessary for providing a total amount of 5 L. The operation was performed in a glass vessel coated with a fluorine resin. The fluorine resin coating has an effect of preventing the hydrophilic nanowires from being attached to the surface of the vessel, so as to enhance the yield.

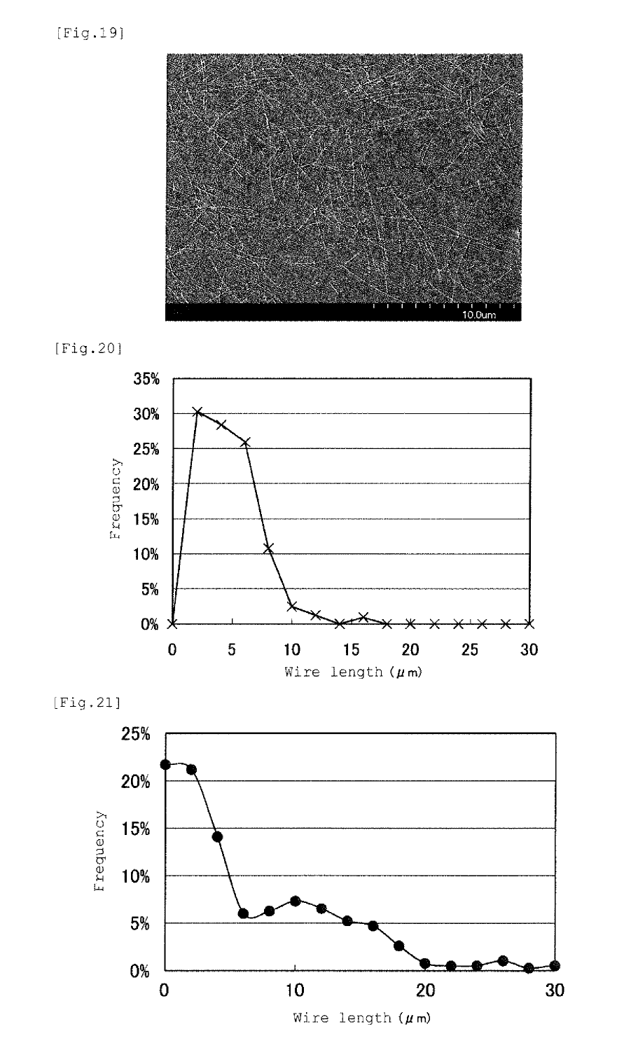

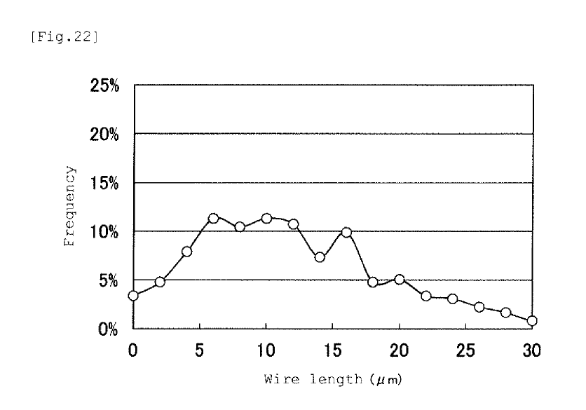

At the time when the rinsing process was completed, the average length of the silver nanowires was 7.4 μm, the average diameter thereof was 27.0 nm, and the average aspect ratio thereof was 7,400/27.0 274. The nanowires of 5.0 μm or less thereof were 50.2%. FIG. 21 shows the length distribution (number ratio) of the silver nanowires after the rinsing process.

In Comparative Example 1 and Example 1, the nanowires (linear particles) having a length of less than 1 μm and the nanoparticles were removed by the method of repeated aggregation and dispersion, but in this example, the aggregation and the dispersion each were performed only once in the rinsing process, and a large amount of the nanowires (linear particles) having a length of less than 1 μm and the nanoparticles remained in the liquid after the rinsing process. Accordingly, the average length and the average diameter of the silver nanowires shown above were measured only for the particles having an aspect ratio of 2 or more, but the nanoparticles were not measured.

### Cross-flow Purification Process

The silver nanowires dispersion liquid obtained through the rinsing process was diluted with pure water to make a silver nanowires concentration of 0.01% by mass, and purified by subjecting to cross-flow filtration using a porous ceramic filter.

The material for the porous ceramic filter used in this example was SiC (silicon carbide), and the dimension thereof was 12 mm for the outer diameter, 9 mm for the inner diameter, and 250 mm for the length. The porous ceramic filter had an average pore diameter of 5.8 μm measured by the mercury intrusion method with a mercury porosimeter, produced by Micrometrics, Inc. (the measurement conditions were the same as in Example 1, the same applied in the following examples).

The cross-flow purification was performed in the same manner as in Example 1 except for the above.

The average length of the silver nanowires after the cross-flow filtration was 13.5 μm, and the number ratio of nanowires of 5.0 μm or less thereof was 12.1%. The average diameter thereof was 27.5 nm, and the average aspect ratio thereof was 13,500/27.5≈490. The nanoparticles remaining in a large amount after the rinsing process (before the cross-flow purification) were markedly removed by the cross-flow filtration. FIG. 22 shows the length distribution (number ratio) of the silver nanowires after the cross-flow purification.

### Example 4

### Cross-flow Purification Process

A ceramic filter formed of Al₂O₃ (alumina) as a material therefor having an average pore diameter of 7.1 μm measured by the mercury intrusion method with a mercury pores imeter was used. The cross-flow purification was performed in the same manner as in Example 3 except for the above.

The average length of the silver nanowires after the cross-flow purification was 14.7 μm, and the number ratio of nanowires of 5.0 μm or less thereof was 6.8%. The average diameter thereof was 27.7 nm, and the average aspect ratio thereof was 14,700/27.7≈531. The nanoparticles remaining in a large amount after the rinsing process (before the cross-flow purification) were markedly removed by the cross-flow filtration.

### Comparative Example 3

### Cross-flow Purification Process

A ceramic filter formed of SiC (silicon carbide) as a material therefor having an average pore diameter of 32.5 μm measured by the mercury intrusion method with a mercury porosimeter was used. The cross-flow purification was performed in the same manner as in Example 3 except for the above.

Substantially the entire amount of the nanowires and the nanoparticles were discharged as a filtrate by the cross-flow filtration. The particle size distribution measured for the nanowires having an aspect ratio of 2 or more in the filtrate was substantially the same as in FIG. 21 (before the cross-flow purification) above.

The nanowires before the cross-flow purification had a considerably small abundance ratio of the long linear particle having a length exceeding 30 μm as shown in FIG. 21. In this example, it was considered that due to the use of the ceramic filter having a large average pore diameter of 32.5 μm, substantially the entire amount of the nanowires were discharged along with the filtrate in the circulation condition used herein.

### Example 5

### Cross-flow Purification Process

A ceramic filter formed of SiC (silicon carbide) as a material therefor having an average pore diameter of 4.6 μm measured by the mercury intrusion method with a mercury porosimeter was used. The cross-flow purification was performed in the same manner as in Example 3 except for the above.

The average length of the silver nanowires after the cross-flow purification was 12.4 μm, and the number ratio of nanowires of 5.0 μm or less thereof was 18.4%. The average diameter thereof was 27.1 nm, and the average aspect ratio thereof was 12,400/27.1≈457. The nanoparticles remaining in a large amount after the rinsing process (before the cross-flow purification) were markedly removed by the cross-flow filtration.

### Example 6

### Cross-flow Purification Process

A ceramic filter formed of Al₂O₃ (alumina) as a material therefor having an average pore diameter of 1.4 μm measured by the mercury intrusion method with a mercury porosimeter was used. The cross-flow purification was performed in the same manner as in Example 3 except for the above.

The average length of the silver nanowires after the cross-flow purification was 10.0 μm, and the number ratio of nanowires of 5.0 μm or less thereof was 28.4%. The average diameter thereof was 27.0 nm, and the average aspect ratio thereof was 10,000/27.0≈370. The nanoparticles remaining in a large amount after the rinsing process (before the cross-flow purification) were markedly removed by the cross-flow filtration.

In this example, due to the use of the ceramic filter having an average pore diameter smaller than in Examples 1 to 5, the number ratio of nanowires of 5.0 μm or less was increased, but the yield of the nanowires recovered was increased. Since the number ratio of nanowires of 5.0 μm or less was approximately 50% (see Example 3) in the state before the cross-flow purification (after the rinsing process in Example 3), the uniformity in length distribution was enhanced by the cross-flow filtration even by using the ceramic filter having an average pore diameter close to 1 μm as in this example.

### REFERENCE SIGN LIST

1 porous ceramic tube
2 upstream flow path tube
3 downstream flow path tube
10 tubular flow path having porous ceramic filter on wall of flow path
20 upstream end of filter
30 downstream end of filter

1. A method for producing metal nanowires, comprising: making metal nanowires to flow accompanied by a flow of a liquid medium in a tubular flow path having, on a wall of the flow path, a porous ceramic filter having an average pore diameter by the mercury intrusion method of 1.0 μm or more; discharging a part of the flowing metal nanowires to an outside of the tubular flow path through the porous ceramic filter along with a part of the liquid medium; and recovering the metal nanowires that flow in the flow path but are not discharged to the outside of the tubular flow path.

2. The method for producing metal nanowires according to claim 1, wherein the porous ceramic filter has an average pore diameter by the mercury intrusion method exceeding 2.0 μm.

3. The method for producing metal nanowires according to claim 1, wherein the porous ceramic filter has an average pore diameter by the mercury intrusion method exceeding 5.0 μm.

4. The method for producing metal nanowires according to claim 1, wherein metal nanowires having a length distribution having a mixture of wires having a length of 5.0 μm or less and wires having a length exceeding 5.0 μm are introduced to the tubular flow path having a porous ceramic filter on a wall of the flow path.

5. The method for producing metal nanowires according to claim 4, wherein the metal nanowires are silver nanowires, and the recovered metal nanowires are silver nanowires having an average length of 8.0 μm or more and a number ratio of wires having a length of 5.0 μm or less of 20% or less.
